(19) United States
(12) Patent Application Publication
(10) Pub. No.: US 2020/0111439 A1
(43) Pub. Date: Apr. 9, 2020

(54) DISPLAY DEVICE AND METHOD OF DRIVING THE SAME

(71) Applicant: Samsung Display Co., Ltd., Yongin-si (KR)

(72) Inventors: Dongkeon KIM, Cheonan-si (KR); Wonjong OHN, Seongnam-si (KR); Seonghyeon KIM, Hwaseong-si (KR); Taehoon KIM, Hwaseong-si (KR); Moah CHOI, Yongin-si (KR); Suji HAN, Incheon (KR)

(21) Appl. No.: 16/556,042

(22) Filed: Aug. 29, 2019

(30) Foreign Application Priority Data
Oct. 5, 2018 (KR) 10-2018-0119167

(51) Int. Cl. G09G 3/36

(52) U.S. Cl. CPC G09G 3/3696; G09G 3/3677; H01G 4/30; G09G 2310/08; G09G 2310/0243; G09G 3/3688

(57) ABSTRACT

A display device may include a driving controller which may receive a first image signal and output a second image signal, a voltage and clock generator may receive a gate pulse signal and may generate a driving voltage and a gate clock signal to drive a data driver and a gate driver. A frame period may include an active period in which the second image signal is applied to the pixels and a blank period, and the driving controller changes a frequency of the first control signal and the gate pulse signal such that the blank period becomes longer during the frame period when the first image signal corresponds to a set image pattern.

### CROSS-REFERENCE TO RELATED APPLICATION

This application claims priority to and the benefit of Korean Patent Application No. 10-2018-0119167, filed on Oct. 5, 2018 in the Korean Intellectual Property Office (KIPO), the content of which is incorporated herein in its entirety by reference.

### BACKGROUND

### 1. Field

The present disclosure relates to a display device and a method of driving the same.

### 2. Description of the Related Art

In general, a display device includes a voltage generator that may convert a power source voltage from an external source to an internal power source voltage, and the voltage generator may include a multi-layer capacitor that stably generates the internal power source voltage.

The multi-layer capacitor may have a structure in which internal electrodes of different polarities are alternately stacked with each other between a plurality of dielectric layers. The multi-layer capacitor may be used as a component in various electronic devices because the multi-layer capacitor has advantages such as small size, high capacity, and easy mounting.

However, when an alternating current voltage is applied to the multi-layer capacitor, a vibration may occur in the dielectric layers, and the vibration may be transmitted to a substrate, thereby causing a vibration sound. When the vibration sound occurs in the display device, a user's discomfort may increase.

### SUMMARY

According to an aspect of embodiments of the present disclosure a display device is capable of reducing or preventing an occurrence of a noise (e.g., an audible noise) generated by electronic circuit components.

According to an aspect of embodiments of the present disclosure a method of driving the display device is capable of reducing or preventing an occurrence of a noise (e.g., an audible noise) generated by electronic circuit components.

According to one or more embodiments, a display device may include a display panel including a plurality of data lines, a plurality of gate lines, and a plurality of pixels connected to the data lines and the gate lines, a driving controller may receive a first image signal and a control signal and may output a second image signal, a first control signal, a second control signal, and a gate pulse signal, a data driver may drive the data lines in response to the first control signal, a gate driver may drive the gate lines in response to the second control signal and a gate clock signal, and a voltage and clock generator may receive the gate pulse signal and may generate a driving voltage and the gate clock signal to drive the data driver and the gate driver. A frame period may include an active period in which the second image signal is applied to the pixels and a blank period, and the driving controller changes a frequency of the first control signal and the gate pulse signal such that the blank period becomes longer during the frame period when the first image signal corresponds to a set image pattern.

The driving controller includes an image signal processing circuit that may convert the first image signal to the second image signal and may output a pattern detection signal when the first image signal corresponds to the set image pattern.

The image signal processing circuit may include a pattern detector that may output the pattern detection signal when the first image signal corresponds to the set image pattern.

One horizontal period determined by a frequency of the first control signal and the second control signal during a noise reduction mode in which the pattern detection signal is in an active state is shorter than a horizontal period during a normal mode in which the pattern detection signal is in an inactive state.

The driving controller may further include a control signal generating circuit that may output the first control signal, the second control signal, and the gate pulse signal in response to the pattern detection signal and the control signal.

The first control signal may include a horizontal synchronization start signal and a load signal, and the second control signal includes a vertical start signal.

The control signal generating circuit may change a frequency of each of the horizontal synchronization start signal, the load signal, and the gate pulse signal during a noise reduction mode in which the pattern detection signal is in an active state to be higher than a frequency of each of the horizontal synchronization start signal, the load signal, and the gate pulse signal during a normal mode.

A frequency of the frame period is the same for the normal mode and the noise reduction mode.

The set image pattern includes a horizontal stripe pattern having a large difference in grayscale value at every a set number of rows of pixels from among the pixels.

The driving controller may change the frequency of the first control signal and the gate pulse signal to allow a ripple frequency of the driving voltage to be out of an audible frequency range when the first image signal is the horizontal stripe pattern having the large difference in grayscale value at every k rows of pixels from among the pixels.

The voltage and clock generator may include a DC-DC converter converting a power source voltage to the driving voltage and may output the driving voltage to an output node, a level shifter receiving the gate pulse signal and outputting the gate clock signal, and a capacitor connected between the output node and a ground voltage.

The set image pattern includes an image pattern that causes the capacitor to generate an audible noise.

In embodiments of the inventive concept, a display device may include a display panel including a plurality of data lines, a plurality of gate lines, and a plurality of pixels connected to the data lines and the gate lines, a driving controller may receive a first image signal and a control signal and may output a second image signal, a first control signal, a second control signal, and a gate pulse signal, and a driving circuit driving the data lines and the gate lines in response to the first control signal, the second control signal, and the gate pulse signal. The driving controller may include an image signal processing circuit that may convert the first image signal to the second image signal and may output a pattern detection signal when the first image signal corresponds to a set image pattern and a control signal generating circuit that may output the first control signal, the second control signal, and the gate pulse signal in response to the pattern detection signal and the control signal. The control signal generating circuit may change a frequency of each of the first control signal and the gate pulse signal when the pattern detection signal is in an active state.

A frame period may include an active period in which the second image signal is applied to the pixels and a blank period, and the control signal generating circuit may change the frequency of the first control signal and the gate pulse signal such that the blank period becomes longer in the frame period when the pattern detection signal is in the active state.

A horizontal period determined by a frequency of the first control signal and the second control signal during a noise reduction mode in which the pattern detection signal is in the active state is shorter than a horizontal period during a normal mode in which the pattern detection signal is in an inactive state.

The first control signal may include a horizontal synchronization start signal and a load signal, and the second control signal includes a vertical start signal.

In embodiments of the inventive concept, a method of driving a display device may include receiving a first image signal, determining whether the first image signal corresponds to a set image pattern, outputting a control signal of a noise reduction mode when the first image signal corresponds to the set image pattern, outputting a control signal of a normal mode when the first image signal does not correspond to the set image pattern, converting the first image signal to a second image signal, and applying the second image signal to a plurality of pixels of a display panel. The control signal of the noise reduction mode has a frequency different from a frequency of the control signal of the normal mode.

A frame period includes an active period in which the second image signal is applied to the pixels and a blank period, and the outputting of control signal of the noise reduction mode includes setting the frequency of the control signal such that the blank period becomes longer.

Each of the control signal of the noise reduction mode and the control signal of the normal mode includes a horizontal synchronization start signal, a load signal, and a gate pulse signal.

The outputting of the control signal of the noise reduction mode includes changing a frequency of each of the horizontal synchronization start signal, the load signal, and the gate pulse signal to be higher than a frequency in the normal mode.

According to the above and in one or more embodiments, the display device may prevent or reduce a noise (e.g., an audible noise) caused by specific image patterns from occurring in the electronic circuit components.

### BRIEF DESCRIPTION OF THE DRAWINGS

The above and other advantages of the present disclosure will become readily apparent by reference to the following detailed description when considered in conjunction with the accompanying drawings.

FIG. 1 is a plan view showing a display device according to an exemplary embodiment of the present disclosure.

FIG. 2 is a block diagram showing a voltage and clock generator of a display device according to an exemplary embodiment of the present disclosure.

FIG. 3 is a cross-sectional view showing a capacitor mounted on a main circuit board shown in FIG. 2.

FIG. 4 is a block diagram showing a display device according to an exemplary embodiment of the present disclosure.

FIG. 5 is a timing diagram showing signals generated in a display device according to an exemplary embodiment of the present disclosure.

FIG. 6 is a view showing an example of an image displayed in a display panel of a display device according to an exemplary embodiment of the present disclosure.

FIG. 7 is a waveform diagram showing a variation in voltage level of a driving voltage when a display device according to an exemplary embodiment of the present disclosure displays the image shown in FIG. 6.

FIG. 8 is a block diagram showing a driving controller of a display device according to an exemplary embodiment of the present disclosure.

FIG. 9 is a timing diagram showing signals generated in a display device during a normal mode and a noise reduction mode according to an exemplary embodiment of the present disclosure.

FIG. 10 is a view showing a ripple generation period and a ripple frequency of a driving voltage according to an image pattern and a frame frequency during the normal mode and the noise reduction mode according to an exemplary embodiment of the present disclosure.

FIG. 11 is a flowchart showing a method of driving a display device according to an exemplary embodiment of the present disclosure.

### DETAILED DESCRIPTION

It will be understood that when an element or layer is referred to as being “on”, “connected to” or “adjacent to” another element or layer, it can be directly on, connected or adjacent to the other element or layer or intervening elements or layers may be present.

Like numerals refer to like elements throughout. In the drawings, the thickness of layers, films, and regions are exaggerated for clarity.

As used herein, the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure. As used herein, the singular forms, “a”, “an” and “the” are intended to include the plural forms as well, unless the context clearly indicates otherwise.

Spatially relative terms, such as “beneath”, “below”, “lower”, “above”, “upper” and the like, may be used herein for ease of description to describe one element or feature's relationship to another element(s) or feature(s) as illustrated in the figures.

The electronic or electric devices and/or any other relevant devices or components according to embodiments of the present disclosure described herein, such as, for example, a driving controller, a voltage and clock generator, a data driver, and a gate driver, may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of ordinary skill in the art should recognize that the functionality of various computing/electronic devices may be combined or integrated into a single computing/electronic device, or the functionality of a particular computing/electronic device may be distributed across one or more other computing/electronic devices without departing from the spirit and scope of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be further understood that the terms “comprises,” “comprising,” “includes” and/or “including”, when used in this specification, specify the presence of stated features, integers, steps, operations, elements, and/or components, but do not preclude the presence or addition of one or more other features, integers, steps, operations, elements, components, and/or groups thereof. Further, the use of “may” when describing embodiments of the inventive concept refers to “one or more embodiments of the inventive concept.” Also, the term “exemplary” is intended to refer to an example or illustration.

As used herein, the term “substantially,” “about,” and similar terms are used as terms of approximation and not as terms of degree, and are intended to account for the inherent deviations in measured or calculated values that would be recognized by those of ordinary skill in the art.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

As used herein, the terms “use,” “using,” and “used” may be considered synonymous with the terms “utilize,” “utilizing,” and “utilized,” respectively.

Hereinafter, the present disclosure will be explained in more detail with reference to the accompanying drawings.

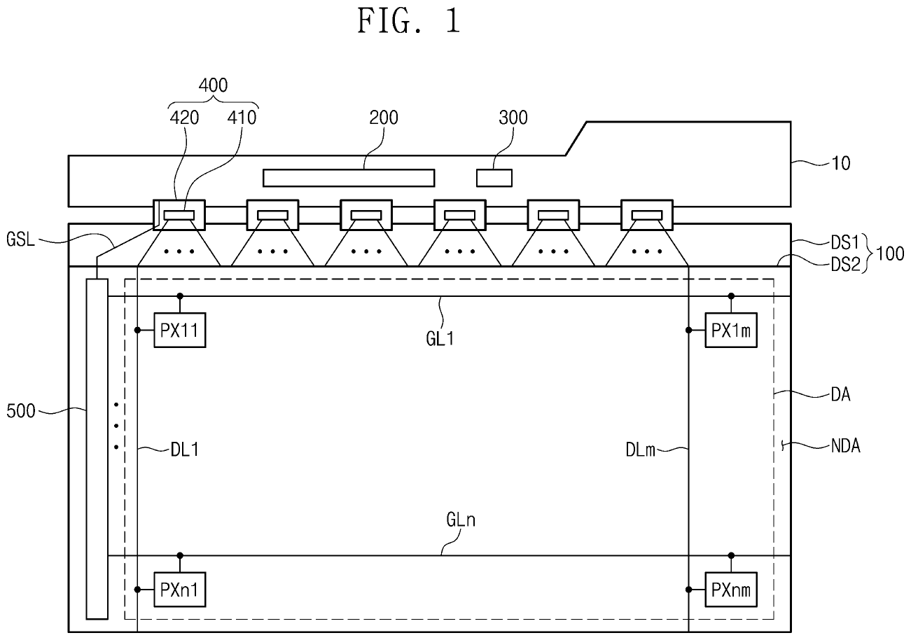

FIG. 1 is a plan view showing a display device according to an exemplary embodiment of the present disclosure.

Referring to FIG. 1, the display device according to an exemplary embodiment of the present disclosure includes a display panel 100, a driving controller 200, a voltage and clock generator 300, a data driver 400, and a gate driver 500.

The display panel 100 should not be particularly limited. For example, various display panels, such as a liquid crystal display panel, an organic light emitting display panel, an electrophoretic display panel, and an electrowetting display panel, may be used as the display panel 100. In a case where the liquid crystal display panel is used as the display panel 100, the display device may further include a backlight unit.

The display panel 100 may include a first substrate DS1 and a second substrate DS2 spaced apart from the first substrate DS1. In the case where the liquid crystal display panel is used as the display panel 100, the display panel 100 may further include a liquid crystal layer between the first substrate DS1 and the second substrate DS2. When viewed in a plan view, the display panel 100 may include a display area DA in which a plurality of pixels PX11 to PXnm is arranged and a non-display area NDA surrounding the display area DA.

The display panel 100 may include a plurality of gate lines GL1 to GLn arranged on the first substrate DS1 and a plurality of data lines DL1 to DLm crossing the gate lines GL1 to GLn. The gate lines GL1 to GLn may be connected to the gate driver 500. The data lines DL1 to DLm may be connected to the data driver 400.

FIG. 1 shows only some pixels from among the pixels PX11 to PXnm. Each of the pixels PX11 to PXnm may be connected to a corresponding gate line from among the gate lines GL1 to GLn and a corresponding data line from among the data lines DL1 to DLm.

The pixels PX11 to PXnm may be grouped into a plurality of groups according to colors displayed thereby. The pixels PX11 to PXnm may each display one primary color. The primary colors may include red, green, blue, and white colors, however, they should not be limited thereto or thereby. That is, the primary colors may further include various suitable colors, such as yellow, cyan, and magenta colors.

The data driver 400 and the gate driver 500 may receive control signals from the driving controller 200. The driving controller 200 and the voltage and clock generator 300 may be mounted on a main circuit board 10. The driving controller 200 may receive image data and control signals from an external graphic control circuit.

The data driver 400 may generate grayscale voltages (gray level voltages) according to second image signals from the driving controller 200 based on a corresponding control signal (hereinafter, referred to as a “first control signal”) of the control signals, which is applied thereto from the driving controller 200. The data driver 400 may apply the grayscale voltages to the data lines DL1 to DLm as data signals.

The data signals may include positive data voltages having a positive value with respect to a common voltage and/or negative data voltages having a negative value with respect to the common voltage. Among data signals applied to the data lines DL1 to DLm, some data signals may have a positive polarity, and other data signals may have a negative polarity. The polarity of the data signals may be inverted every frame to prevent or protect liquid crystals from burning and deteriorating. The data driver 400 may generate the data signals that are inverted every frame period in response to an inversion signal.

The data driver 400 may include a driving chip 410 and a flexible printed circuit board 420 on which the driving chip 410 may be mounted. The data driver 400 may include a plurality of driving chips 410 and a plurality of flexible printed circuit boards 420. The flexible printed circuit board 420 may electrically connect the main circuit board 10 and the first substrate DS1. The driving chips 410 may apply the data signals to corresponding data lines from among the data lines DL1 to DLm.

FIG. 1 shows a chip-on-film (COF) type data driver 400 as a representative example. According to another embodiment, the data driver 400 may be in the non-display area NDA of the first substrate DS1 in a chip-on-glass (COG) manner.

The gate driver 500 may generate gate signals G1 to Gn based on the control signal (hereinafter, referred to as a “second control signal”) applied thereto from the driving controller 200 through a signal line GSL and may apply the gate signals G1 to Gn to the gate lines GL1 to GLn. The gate signals G1 to Gn may be sequentially output at an active level (e.g., high level). The gate driver 500 may be substantially simultaneously or concurrently formed with the pixels PX11 to PXnm through a thin film process. For instance, the gate driver 500 may be mounted in the non-display area NDA of the display panel 100 in an oxide semiconductor TFT gate driver circuit (OSG) manner.

FIG. 1 shows a gate driver 500 connected to left ends of the gate lines GL1 to GLn as a representative example. In an exemplary embodiment of the present disclosure, the display device may include two gate driving circuits. One gate driving circuit of the two gate driving circuits may be connected to the left ends of the gate lines GL1 to GLn, and the other gate driving circuit of the two gate driving circuits may be connected to right ends of the gate lines GL1 to GLn. In addition, one gate driving circuit of the two gate driving circuits may be connected to odd-numbered gate lines (e.g., gate lines that are not directly adjacent to each other) of the gate lines GL1 to GLn, and the other gate driving circuit of the two gate driving circuits may be connected to even-numbered gate lines (e.g., gate lines that are not directly adjacent to each other) of the gate lines GL1 to GLn.

The voltage and clock generator 300 may generate various suitable driving voltages and various suitable clock signals, which are required for an operation of the display device. For example, the voltage and clock generator 300 may output a driving voltage AVDD required for the operation of the data driver 400 and may output a gate clock signal CKV required for the operation of the gate driver 500.

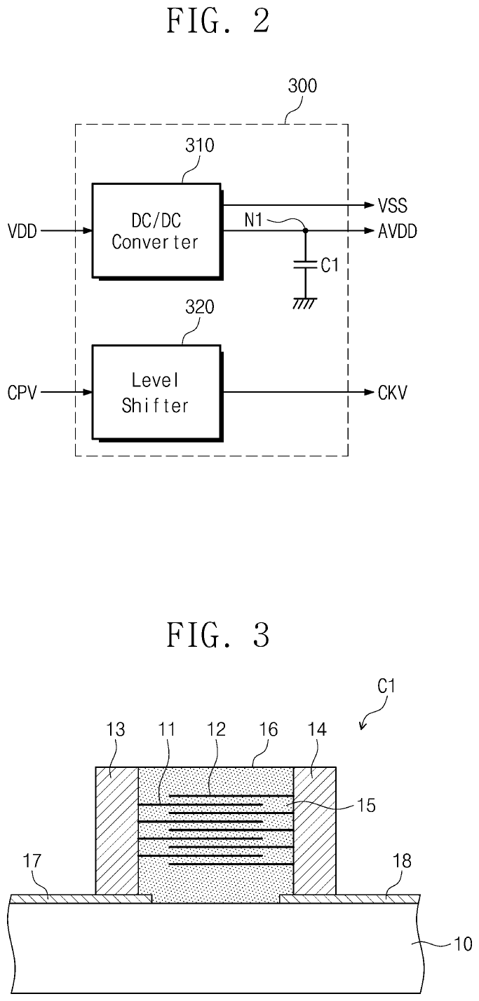

FIG. 2 is a block diagram showing the voltage and clock generator 300 of the display device according to an exemplary embodiment of the present disclosure.

Referring to FIG. 2, the voltage and clock generator 300 may include a direct-current-to-direct-current (DC-DC) converter 310, a level shifter 320, and a capacitor C1. The DC-DC converter 310 may receive a power source voltage VDD and may output the driving voltage AVDD to a first node N1. The capacitor C1 may be connected between the first node N1 and a ground voltage. The capacitor C1 may include a multi-layer ceramic capacitor. The DC-DC converter 310 may further generate a driving voltage VSS required for the operation of the gate driver 500.

The level shifter 320 may receive a gate pulse signal CPV from the driving controller 200 shown in FIG. 1 and may output the gate clock signal CKV. The gate clock signal CKV may be a pulse signal swung between a gate high voltage and a gate low voltage. The gate high voltage may have a voltage level sufficient to turn on switching transistors included in the pixels PX11 to PXnm shown in FIG. 1.

FIG. 3 is a cross-sectional view showing the capacitor C1 mounted on the main circuit board shown in FIG. 2.

Referring to FIG. 3, the capacitor C1 corresponding to the multi-layer ceramic capacitor (MLCC) may include a first internal electrode 11, a second internal electrode 12, a first electrode 13, a second electrode 14, a dielectric substance 15, and a housing 16.

The first internal electrodes 11 may be alternately stacked with the second internal electrodes 12 in the housing 16. The first internal electrodes 11 may be connected to the first electrode 13, and the second internal electrodes 12 may be connected to the second electrode 14. The first internal electrode 11 and the second internal electrode 12 may have a thin plate shape and may be insulated from each other by the dielectric substance 15 filled in the housing 16.

A first wiring line 17 and a second wiring line 18 may be on one surface (e.g., the same surface) of the main circuit board 10. The first wiring line 17 and the second wiring line 18 may be on an upper surface of the main circuit board 10, and different voltages may be applied to the first and second wiring lines 17 and 18. For example, the driving voltage AVDD from the DC-DC converter 310 may be applied to the first wiring line 17, and the ground voltage may be applied to the second wiring line 18. The driving voltage AVDD provided through the first wiring line 17 may be applied to the first electrode 13 of the capacitor C1, and the ground voltage provided through the second wiring line 18 may be applied to the second electrode 14 of the capacitor C1.

When the driving voltage AVDD and the ground voltage are respectively applied to the first electrode 13 and the second electrode 14 of the capacitor C1, a vibration may occur in the first internal electrode 11 and the second internal electrode 12 due to a piezoelectric effect. The vibration occurring in the capacitor C1 may act as a vibration source that causes the main circuit board 10 to vibrate. When a vibration frequency of the capacitor C1 is in an audible frequency range, a noise (e.g., an audible noise) may occur.

The driving voltage AVDD output from the DC-DC converter 310 shown in FIG. 2 may be applied to the data driver 400 shown in FIG. 1. A ripple phenomenon in which the voltage level of the driving voltage AVDD fluctuates may occur depending on the image displayed through the display panel 100. In particular, when a ripple generation period corresponds to the audible frequency range, the vibration of the capacitor C1 may be heard as a noise.

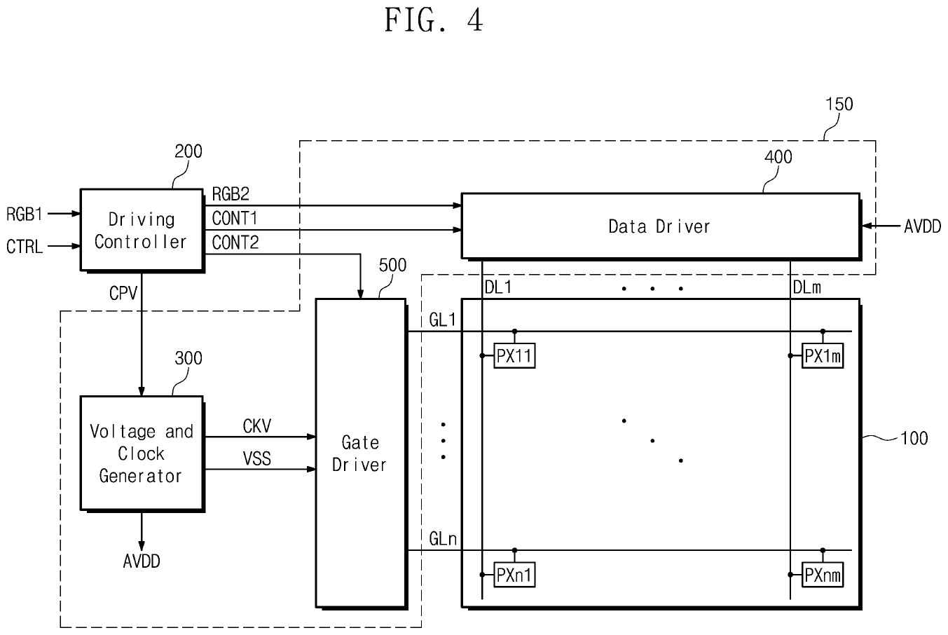

FIG. 4 is a block diagram showing the display device according to an exemplary embodiment of the present disclosure.

Referring to FIG. 4, the display panel 100 may include the gate lines GL1 to GLn, the data lines DL1 to DLm, and the pixels PX11 to PXnm arranged with each other in areas defined by the gate lines GL1 to GLn and the data lines DL1 to DLm. Each of the pixels PX11 to PXnm may be connected to a corresponding gate line from among the gate lines GL1 to GLn and a corresponding data line from among the data lines DL1 to DLm.

The driving controller 200 may receive first image signals RGB1 and the control signals CTRL (e.g., a vertical synchronization signal, a horizontal synchronization signal, a main clock signal, and a data enable signal). The driving controller 200 may apply the second image signals RGB2, which may be obtained by processing the first image signals RGB1 by taking into account an operating condition of the display panel 100 based on the control signals CTRL. The driving controller 200 may apply the first control signal CONT1 to the data driver 400 and may apply the second control signal CONT2 to the gate driver 500. The first control signal CONT1 may include a clock signal, a horizontal synchronization start signal, a polarity inversion signal, and a line latch signal The second control signal CONT2 may include a vertical synchronization start signal. In addition, the driving controller 200 may apply the gate pulse signal CPV based on the control signals CTRL to the voltage and clock generator 300.

A driving circuit 150 may include the voltage and clock generator 300, the data driver 400, and the gate driver 500.

The voltage and clock generator 300 may receive the gate pulse signal CPV, and may apply the gate clock signal CKV and the driving voltage VSS to the gate driver 500. The voltage and clock generator 300 may apply the driving voltage AVDD to the data driver 400. In the present exemplary embodiment, the voltage and clock generator 300 may output only one gate clock signal CKV, however, according to another embodiment, the voltage and clock generator 300 may apply two or more gate clock signals having the same frequency as and different phases from each other to the gate driver 500.

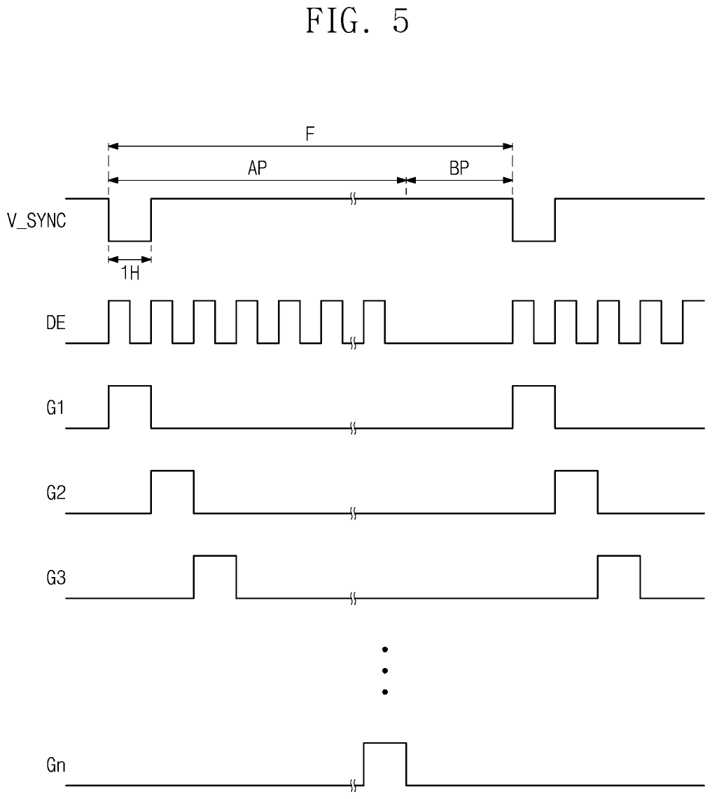

FIG. 5 is a timing diagram showing signals generated in the display device according to an exemplary embodiment of the present disclosure.

Referring to FIGS. 4-5, the vertical synchronization signal V_SYNC and the data enable signal DE may be signals included in the control signals CTRL applied to the driving controller 200 from an external source.

The vertical synchronization signal V_SYNC may have an active level, for example, a low level, every one frame period F. The data enable signal DE is a pulse signal transited every 1 horizontal period (1H).

The one frame period F may include an active period AP and a blank period BP. During the active period AP, the data enable signal DE may include the number of pulses corresponding to the number of gate lines GL1 to GLn. During the blank period BP, the data enable signal DE is maintained at a predetermined or set level, for example, a low level.

The gate signals G1 to Gn may be generated by the gate driver 500 and may be applied to the gate lines GL1 to GLn. The gate signals G1 to Gn may be sequentially activated (e.g., sequentially receive signals at a high level) during the one frame period F.

For example, the data signals may be applied to the pixels PX11 to PX1m arranged with each other in the same row and connected to the gate line GL1 when the high level of the gate signal G1 is applied to the gate line GL1. That is, the 1 horizontal period 1H is a time period in which pixels (e.g., the pixels PX11 to PX1m) arranged in the same one row are driven.

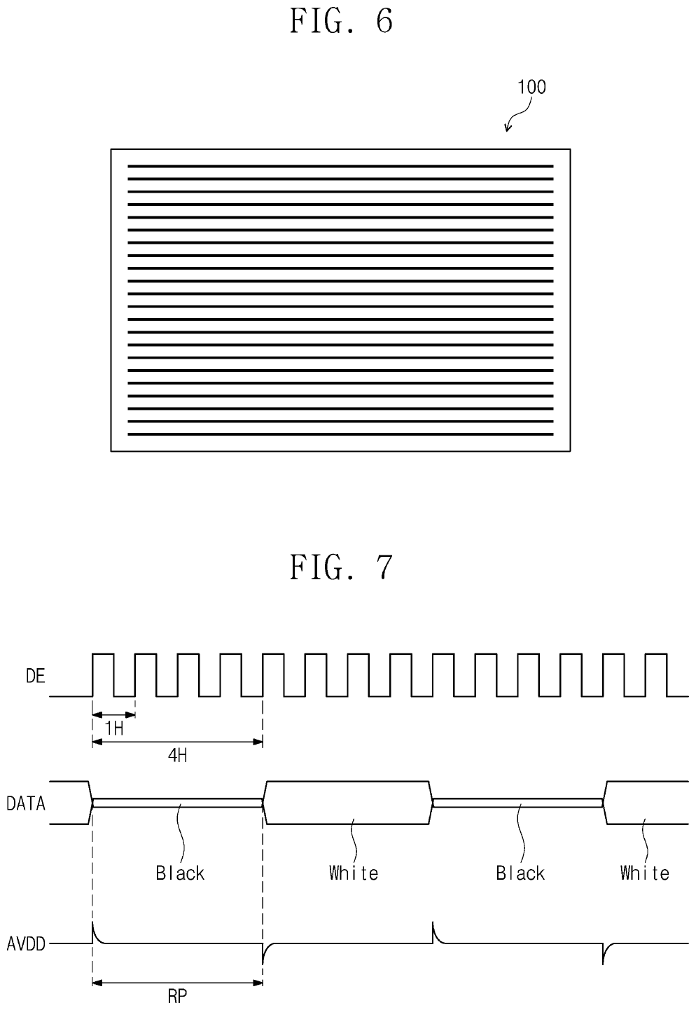

FIG. 6 is a view showing an example of the image displayed in the display panel of the display device.

FIG. 7 is a waveform diagram showing a variation in voltage level of the driving voltage when the display device displays the image shown in FIG. 6 according to an exemplary embodiment of the present disclosure.

Referring to FIGS. 6-7, a horizontal stripe pattern may be displayed through the display panel 100. The horizontal stripe pattern may be an image pattern having a large difference in grayscale value (gray level value) at every predetermined or set number of rows, e.g., at every four rows.

The data signal DATA may be applied to the data lines DL1 to DLm of the display panel 100 from the data driver 400 shown in FIG. 4. The data signal DATA may be signals inverted every one or more frame periods. For example, the data signal DATA may be a horizontal stripe pattern in which an image corresponding to a black grayscale level (black gray level) and an image corresponding to a white grayscale level (white gray level) are alternately displayed with each other. When the data signal DATA corresponding to the white grayscale level is output after the data signal DATA corresponding to the black grayscale level is output during four periods (4H) of the data enable signal DE (i.e., to four rows of the display panel 100) and when the data signal DATA corresponding to the black grayscale level is output after the data signal DATA corresponding to the white grayscale level is output during the four periods (4H), a ripple may occur in the driving voltage AVDD. This is due to a current consumption that varies with the grayscale level of the data signal DATA.

For example, when the data signal DATA corresponds to k by k (k×k) horizontal stripe pattern in which the image corresponding to the black grayscale level and the image corresponding to the white grayscale level are alternately displayed every k row(s), the ripple generation period RP and a ripple frequency FRP may be calculated by the following Equation.

$${}^{1} HP = [ μ s ] = \frac{1}{FR \times Vtotal} \\ RP = {}^{1} HP \times k \\ FRP [ Hz ] = \frac{1}{RP} \qquad Equation$$

In the Equation, “1HP” denotes a time of the 1 horizontal period (1H), “FR” denotes the frame frequency, and the number of horizontal lines (Vtotal) is obtained by adding the number of the pulses of the data enable signal DE in the active period AP (Vactive) to the number of the pulses of the data enable signal DE in the blank period BP (Vblank) (Vtotal=Vactive+Vblank). The data enable signal DE is maintained at the low level for the blank period BP, and the number of the pulses of the data enable signal DE in the blank period BP may be obtained by calculating the number of the pulses of the data enable signal DE for the time period corresponding to the blank period BP.

For example, when the data signal DATA corresponds to 4 by 4 (4×4) horizontal stripe pattern in which the image corresponding to the black grayscale level and the image corresponding to the white grayscale level are alternately displayed every four rows, the frame frequency FR is about 60 Hz, Vactive is about 1080, Vblank is about 50, and the number of the horizontal lines Vtotal is about 1130, the ripple generation period RP is about 59 μs, and the ripple frequency FRP is about 16,950 Hz. Because the audible frequency of a human ear is in a range from about 20 Hz to about 20,000 Hz, the ripple frequency FRP, i.e., about 16,950 Hz, may be heard as a vibration sound.

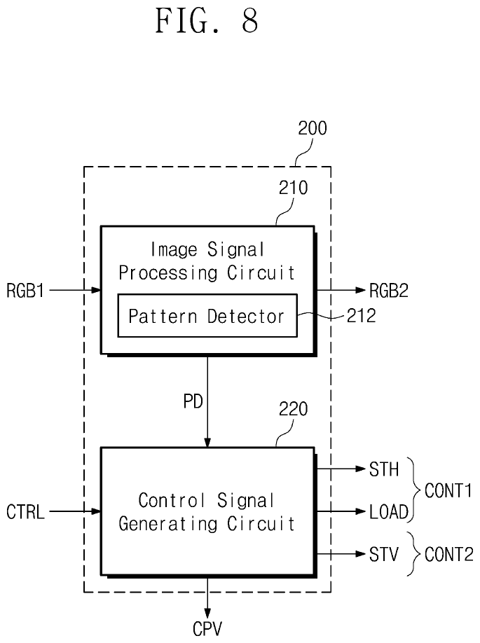

FIG. 8 is a block diagram showing the driving controller 200 of the display device according to an exemplary embodiment of the present disclosure.

Referring to FIG. 8, the driving controller 200 may include an image signal processing circuit 210 and a control signal generating circuit 220. The image signal processing circuit 210 may convert the first image signals RGB1 from an external source to the second image signals RGB2 and may output a pattern detection signal PD when the first image signals RGB1 correspond to a predetermined or set image pattern.

The driving controller 200 may include a pattern detector 212 that determines whether the first image signals RGB1 correspond to the predetermined or set image pattern and may output the pattern detection signal PD. The pattern detector 212 may output the pattern detection signal PD at a first level, for example, the high level, when the first image signals RGB1 correspond to the horizontal stripe pattern having a large difference in grayscale value at every predetermined or set number of pixel rows (rows of pixels). The pattern detector 212 may output the pattern detection signal PD at a second level, for example, the low level, when the first image signals RGB1 do not correspond to the horizontal stripe pattern having a large difference in grayscale value at every predetermined or set number of pixel rows. According to another embodiment, the pattern detector 212 may output the pattern detection signal PD at the first level, for example, the high level, when the first image signals RGB1 correspond to the predetermined or set image pattern that may cause the capacitor shown in FIG. 3 to generate a noise (e.g., an audible noise).

The control signal generating circuit 220 may output the first control signal CONT1, the second control signal CONT2, and the gate pulse signal CPV in response to the pattern detection signal PD and the control signals CTRL. The first control signal CONT1 may include the horizontal synchronization start signal STH and the line latch signal LOAD. The control signal generating circuit 220 may further output the clock signal and the polarity inversion signal as the first control signal CONT1. The first control signal CONT1 may be applied to the data driver 400 shown in FIG. 4. The second control signal CONT2 may include the vertical synchronization start signal STV. The second control signal CONT2 may be applied to the gate driver 500 shown in FIG. 4. The gate pulse signal CPV may be applied to the voltage and clock generator 300 shown in FIG. 4.

The control signal generating circuit 220 may be operated in a noise reduction mode when the pattern detection signal PD has the first level, for example, the high level, and may be operated in a normal mode when the pattern detection signal PD has the second level, for example, the low level.

The control signal generating circuit 220 may change a frequency of the horizontal synchronization start signal STH, the line latch signal LOAD, and the gate pulse signal CPV such that the blank period BP becomes longer in the one frame period F during the noise reduction mode in which the pattern detection signal PD has the first level, for example, the high level.

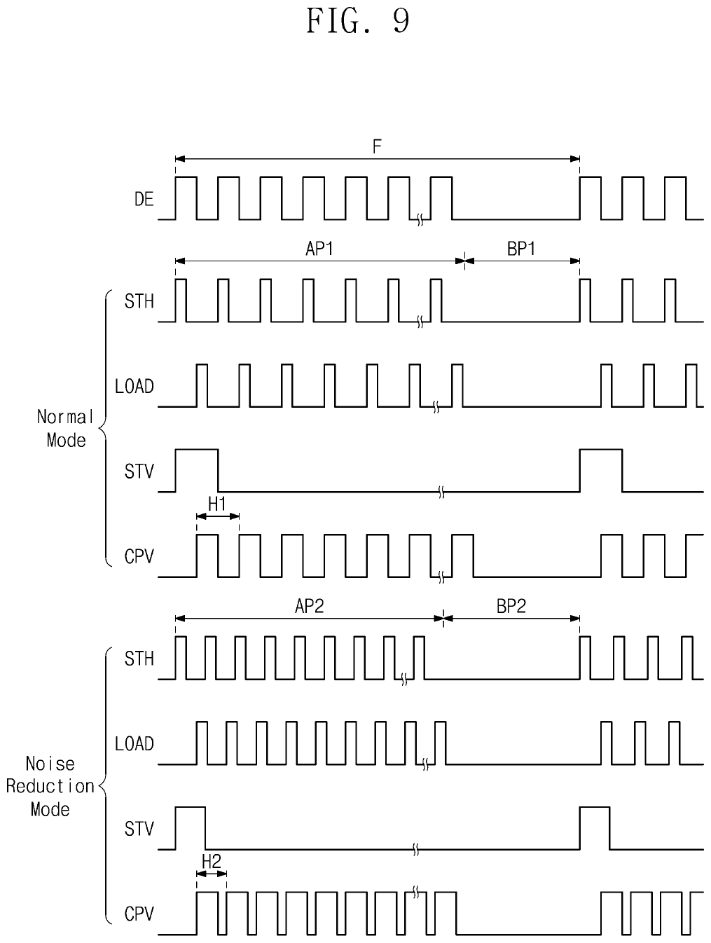

FIG. 9 is a timing diagram showing signals generated in the display device according to an exemplary embodiment of the present disclosure during the normal mode and the noise reduction mode.

Referring to FIGS. 8-9, during the normal mode in which the pattern detection signal PD has the second level, for example, the low level, the control signal generating circuit 220 may output the horizontal synchronization start signal STH, the line latch signal LOAD, the vertical synchronization start signal STV, and the gate pulse signal CPV of the normal mode in synchronization with the vertical synchronization signal, the horizontal synchronization signal, the main clock signal, and the data enable signal DE, which may be included in the control signals CTRL. During the normal mode, the one frame period F may include a first active period AP1 and a first blank period BP1.

During the noise reduction mode in which the pattern detection signal PD has the first level, for example, the high level, the control signal generating circuit 220 may output the horizontal synchronization start signal STH, the line latch signal LOAD, the vertical synchronization start signal STV, and the gate pulse signal CPV of the noise reduction mode in synchronization with the vertical synchronization signal, the horizontal synchronization signal, the main clock signal, and the data enable signal DE, which are included in the control signals CTRL.

During the noise reduction mode, the one frame period F may include a second active period AP2 and a second blank period BP2. The second blank period BP2 of the noise reduction mode may be longer than the first blank period BP1 of the normal mode (BP2>BP1). That is, the second active period AP2 of the noise reduction mode may be shorter than the first active period AP1 of the normal mode.

In other words, the frequency of the horizontal synchronization start signal STH, the line latch signal LOAD, and the gate pulse signal CPV of the second active period AP2 of the noise reduction mode may be higher than the frequency of the horizontal synchronization start signal STH, the line latch signal LOAD, and the gate pulse signal CPV of the first active period AP1 of the normal mode.

The number of pulses of each of the horizontal synchronization start signal STH, the line latch signal LOAD, and the gate pulse signal CPV in the one frame period F is equal to the number of the gate lines GL1 to GLn of the display panel 100 shown in FIG. 4. Because the frequency of the horizontal synchronization start signal STH, the line latch signal LOAD, and the gate pulse signal CPV of the noise reduction mode is higher than the normal mode, a 1 horizontal period H2 of the noise reduction mode is shorter than the 1 horizontal period H1 of the normal mode.

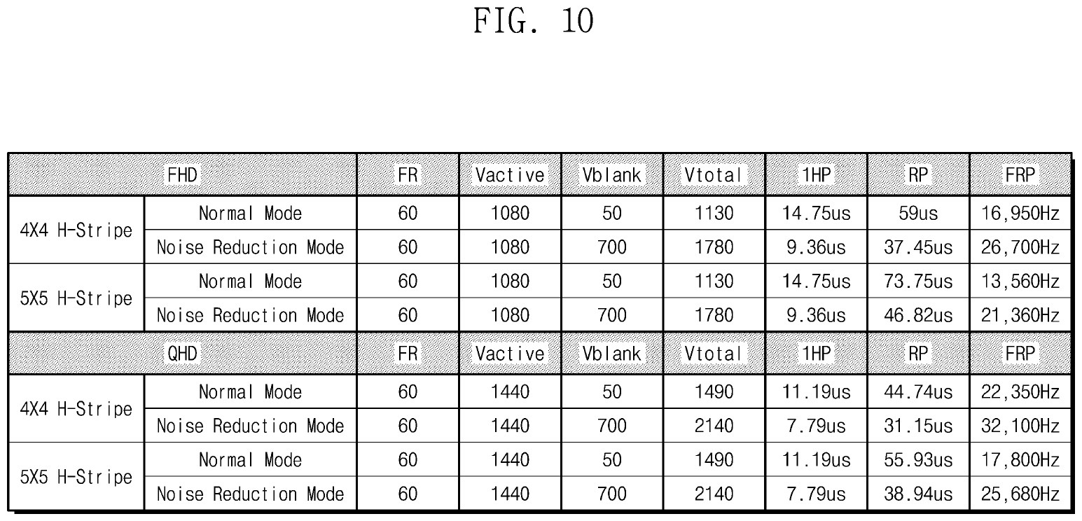

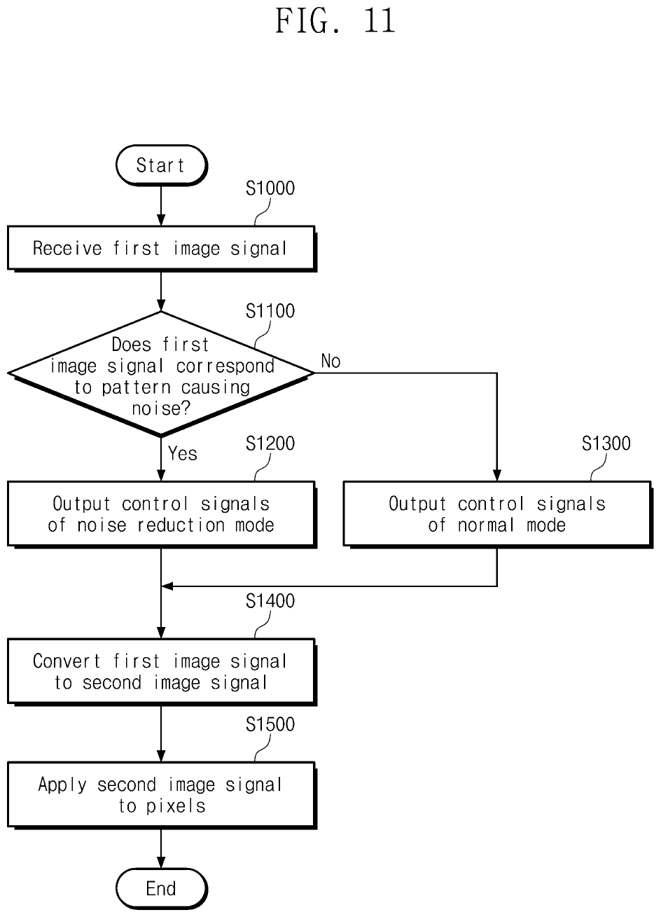

FIG. 10 is a view showing the ripple generation period and the ripple frequency of the driving voltage depending on the image pattern and the frame frequency during the normal mode and the noise reduction mode according to an exemplary embodiment of the present disclosure.

Referring to FIG. 10, when the control signal generating circuit 220 (refer to FIG. 8) is operated in the normal mode and the first image signals RGB1 correspond to the 4 by 4 (4×4) horizontal stripe pattern H-stripe in which the image corresponding to the black grayscale level and the image corresponding to the white grayscale level are alternately displayed every four rows, the frame frequency FR may be about 60 Hz, Vactive may be about 1080, Vblank may be about 50, the number of the horizontal lines Vtotal may be about 1130, the ripple generation period RP may be about 59 μs, and the ripple frequency FRP may be about 16,950 Hz. Because the audible frequency of human ear is in a range from about 20 Hz to about 20,000 Hz, the user may hear the vibration noise of the capacitor C1 when the ripple frequency FRP of the driving voltage AVDD is about 16,950 Hz.

When the first image signals RGB1 correspond to the 4 by 4 (4×4) horizontal stripe pattern and the control signal generating circuit 220 (refer to FIG. 8) is operated in the noise reduction mode, the blank period becomes longer (e.g., increases in duration) as indicated by the second blank period BP2. Accordingly, the number of the horizontal lines Vtotal may increase to about 1780, the ripple generation period RP may be about 37.45 μs, and the ripple frequency FRP may be about 26,700 Hz.

Because the ripple frequency FRP may change (e.g., increase) from about 16,950 Hz to about 26,700 Hz, the noise caused by the vibration of the capacitor C1 may not be heard by the user.

As another example, when the control signal generating circuit 220 (refer to FIG. 8) is operated in the normal mode and the first image signals RGB1 correspond to 5 by 5 (5×5) horizontal stripe pattern H-stripe in which the image corresponding to the black grayscale level and the image corresponding to the white grayscale level are alternately displayed every five rows, the frame frequency FR may be about 60 Hz, Vactive may be about 1080, Vblank may be about 50, the number of the horizontal lines Vtotal may be about 1130, the ripple generation period RP may be about 73.75 μs, and the ripple frequency FRP is about 13,560 Hz. When the ripple frequency FRP of the driving voltage AVDD may be about 13,560 Hz, the user may hear the vibration noise of the capacitor C1.

When the first image signals RGB1 correspond to the 5 by 5 (5×5) horizontal stripe pattern and the control signal generating circuit 220 (refer to FIG. 8) is operated in the noise reduction mode, the blank period becomes longer (e.g., increases in duration) to the second blank period BP2. Accordingly, the number of the horizontal lines Vtotal may increase to about 1780, the ripple generation period RP may be about 46.82 μs, and the ripple frequency FRP may be about 21,360 Hz.

Because the ripple frequency FRP may change (e.g., increases) from about 13,560 Hz to about 21,360 Hz, the noise caused by the vibration of the capacitor C1 may not be heard by the user.

As another example, when the control signal generating circuit 220 (refer to FIG. 8) is operated in the normal mode and the first image signals RGB1 correspond to the 4 by 4 (4×4) horizontal stripe pattern H-stripe in which the image corresponding to the black grayscale level and the image corresponding to the white grayscale level are alternately displayed every four rows, the frame frequency FR may be about 60 Hz, Vactive may be about 1440, Vblank may be about 50, the number of the horizontal lines Vtotal may be about 1490, the ripple generation period RP may be about 44.74 μs, and the ripple frequency FRP may be about 22,350 Hz (which is close to an audible noise as described above).

When the first image signals RGB1 correspond to the 4 by 4 (4×4) horizontal stripe pattern and the control signal generating circuit 220 (refer to FIG. 8) is operated in the noise reduction mode, the blank period becomes longer to the second blank period BP2. Accordingly, the number of the horizontal lines Vtotal may increase to about 2140, the ripple generation period RP may be about 31.15 μs, and the ripple frequency FRP may be about 32,100 Hz.

Because the ripple frequency FRP may change from about 22,350 Hz to about 32,100 Hz, the noise caused by the vibration of the capacitor C1 may not be heard by the user (which may certainly not be heard).

As another example, when the control signal generating circuit 220 (refer to FIG. 8) is operated in the normal mode and the first image signals RGB1 correspond to the 5 by 5 (5×5) horizontal stripe pattern H-stripe in which the image corresponding to the black grayscale level and the image corresponding to the white grayscale level are alternately displayed every five rows, the frame frequency FR may be about 60 Hz, Vactive may be about 1440, Vblank may be about 50, the number of the horizontal lines Vtotal may be about 1490, the ripple generation period RP may be about 55.93 μs, and the ripple frequency FRP may be about 17,800 Hz.

When the first image signals RGB1 correspond to the 5 by 5 (5×5) horizontal stripe pattern and the control signal generating circuit 220 (refer to FIG. 8) is operated in the noise reduction mode, the blank period becomes longer to the second blank period BP2. Accordingly, the number of the horizontal lines Vtotal may increase to about 2140, the ripple generation period RP may be about 38.94 μs, and the ripple frequency FRP may be about 25,680 Hz.

Because the ripple frequency FRP may change from about 17,800 Hz to about 25,680 Hz, the noise caused by the vibration of the capacitor C1 may not be heard by the user.

FIG. 11 is a flowchart showing a method of driving the display device according to an exemplary embodiment of the present disclosure.

For the convenience of explanation, the driving method of the display device in FIG. 11 will be described with reference to the display device shown in FIG. 4, however, it should not be limited thereto or thereby. Referring to FIGS. 4-11, the driving controller 200 may receive the first image signals RGB1 (S1000).

The driving controller 200 may determine whether the first image signals RGB1 correspond to a pattern that causes a noise (S1100). For example, when the first image signals RGB1 correspond to the 4 by 4 (4×4) or 5 by 5 (5×5) horizontal stripe pattern shown in FIG. 6, the driving controller 200 may determine that the first image signals RGB1 correspond to the pattern causing a noise (e.g., an audible noise). When the first image signals RGB1 correspond to the pattern that causes the noise, the driving controller 200 may output the first control signal CONT1, the second control signal CONT2, and the gate pulse signal CPV of the noise reduction mode (S1200).

When the first image signals RGB1 do not correspond to a pattern that causes a noise, the driving controller 200 may output the first control signal CONT1, the second control signal CONT2, and the gate pulse signal CPV of the normal mode (S1300).

As described in FIG. 9, the frequency of the horizontal synchronization start signal STH, the line latch signal LOAD, and the gate pulse signal CPV of the first control signal CONT1 during the noise reduction mode may be higher than the frequency of the horizontal synchronization start signal STH, the line latch signal LOAD, and the gate pulse signal CPV of the first control signal CONT1 during the normal mode. The frequency of the horizontal synchronization start signal STH, the line latch signal LOAD, and the gate pulse signal CPV may be set to allow the ripple generation period RP of the driving voltage AVDD to be out of the audible frequency range (e.g., greater than the audible frequency range).

The driving controller 200 may convert the first image signals RGB1 to the second image signals RGB2 (S1400).

The voltage and clock generator 300 of the driving circuit 150 may receive the gate pulse signal CPV and may output the driving voltages AVDD and VSS and the gate clock signal CKV. The data driver 400 of the driving circuit 150 may drive the data lines DL1 to DLm in response to the second image signals RGB2 and the first control signal CONT1. The gate driver 500 of the driving circuit 150 may drive the gate lines GL1 to GLn in response to the second control signal CONT2, the gate clock signal CKV, and the driving voltage VSS. Accordingly, the second image signals RGB2 may be applied to the pixels PX11 to PXnm of the display panel 100 (S1500). Although the exemplary embodiments of the present disclosure have been described, it is understood that the present disclosure should not be limited to these exemplary embodiments but various changes and modifications can be made by one ordinary skilled in the art within the spirit and scope of the present disclosure as hereinafter claimed. Therefore, the disclosed subject matter should not be limited to any single embodiment described herein, and the scope of the present inventive concept shall be determined according to the attached claims, and equivalents thereof.

What is claimed is:

1. A display device comprising:
a display panel comprising a plurality of data lines, a plurality of gate lines, and a plurality of pixels connected to the data lines and the gate lines;
a driving controller configured to receive a first image signal and a control signal and to output a second image signal, a first control signal, a second control signal, and a gate pulse signal;
a data driver configured to drive the data lines in response to the first control signal;
a gate driver configured to drive the gate lines in response to the second control signal and a gate clock signal; and
a voltage and clock generator configured to receive the gate pulse signal and to generate a driving voltage and the gate clock signal to drive the data driver and the gate driver, wherein a frame period comprises an active period in which the second image signal is applied to the pixels and a blank period, and the driving controller changes a frequency of the first control signal and the gate pulse signal such that the blank period becomes longer during the frame period when the first image signal corresponds to a set image pattern.

2. The display device of claim 1, wherein the driving controller comprises an image signal processing circuit configured to convert the first image signal to the second image signal and to output a pattern detection signal when the first image signal corresponds to the set image pattern.

3. The display device of claim 2, wherein the image signal processing circuit comprises a pattern detector configured to output the pattern detection signal when the first image signal corresponds to the set image pattern.

4. The display device of claim 2, wherein a horizontal period determined by a frequency of the first control signal and the second control signal during a noise reduction mode in which the pattern detection signal is in an active state is shorter than a horizontal period during a normal mode in which the pattern detection signal is in an inactive state.

5. The display device of claim 2, wherein the driving controller further comprises a control signal generating circuit configured to output the first control signal, the second control signal, and the gate pulse signal in response to the pattern detection signal and the control signal.

6. The display device of claim 5, wherein the first control signal comprises a horizontal synchronization start signal and a load signal, and wherein the second control signal comprises a vertical start signal.

7. The display device of claim 6, wherein the control signal generating circuit is configured to change a frequency of each of the horizontal synchronization start signal, the load signal, and the gate pulse signal during a noise reduction mode in which the pattern detection signal is in an active state to be higher than a frequency of each of the horizontal synchronization start signal, the load signal, and the gate pulse signal during a normal mode.

8. The display device of claim 7, wherein a frequency of the frame period is the same for the normal mode and the noise reduction mode.

9. The display device of claim 1, wherein the set image pattern comprises a horizontal stripe pattern having a large difference in grayscale value at every set number of rows of pixels from among the pixels.

10. The display device of claim 9, wherein the driving controller is configured to change the frequency of the first control signal and the gate pulse signal to allow a ripple frequency of the driving voltage to be out of an audible frequency range when the first image signal is the horizontal stripe pattern having the large difference in grayscale value at every k rows of pixels from among the pixels.

11. The display device of claim 1, wherein the voltage and clock generator comprises:
a DC-DC converter configured to convert a power source voltage to the driving voltage and to output the driving voltage to an output node;
a level shifter configured to receive the gate pulse signal and to output the gate clock signal; and
a capacitor connected between the output node and a ground voltage.

12. The display device of claim 11, wherein the set image pattern comprises an image pattern that causes the capacitor to generate an audible noise.

13. A display device comprising:
a display panel comprising a plurality of data lines, a plurality of gate lines, and a plurality of pixels connected to the data lines and the gate lines;
a driving controller configured to receive a first image signal and a control signal and to output a second image signal, a first control signal, a second control signal, and a gate pulse signal; and
a driving circuit configured to drive the data lines and the gate lines in response to the first control signal, the second control signal, and the gate pulse signal, the driving controller comprising:
an image signal processing circuit configured to convert the first image signal to the second image signal and to output a pattern detection signal when the first image signal corresponds to a set image pattern; and
a control signal generating circuit configured to output the first control signal, the second control signal, and the gate pulse signal in response to the pattern detection signal and the control signal, wherein the control signal generating circuit is configured to change a frequency of each of the first control signal and the gate pulse signal when the pattern detection signal is in an active state.

14. The display device of claim 13, wherein a frame period comprises an active period in which the second image signal is applied to the pixels and a blank period, and the control signal generating circuit is configured to change the frequency of the first control signal and the gate pulse signal such that the blank period becomes longer in the frame period when the pattern detection signal is in the active state.

15. The display device of claim 14, wherein a horizontal period determined by a frequency of the first control signal and the second control signal during a noise reduction mode in which the pattern detection signal is in the active state is shorter than a horizontal period during a normal mode in which the pattern detection signal is in an inactive state.

16. The display device of claim 13, wherein the first control signal comprises a horizontal synchronization start signal and a load signal, and wherein the second control signal comprises a vertical start signal.

17. A method of driving a display device, the method comprising:
receiving a first image signal;
determining whether the first image signal corresponds to a set image pattern;
outputting a control signal of a noise reduction mode when the first image signal corresponds to the set image pattern;
outputting a control signal of a normal mode when the first image signal does not correspond to the set image pattern;
converting the first image signal to a second image signal; and
applying the second image signal to a plurality of pixels of a display panel, wherein the control signal of the noise reduction mode has a frequency different from a frequency of the control signal of the normal mode.

18. The method of claim 17, wherein a frame period comprises an active period in which the second image signal is applied to the pixels and a blank period, and wherein the outputting of the control signal of the noise reduction mode comprises setting the frequency of the control signal such that the blank period becomes longer.

19. The method of claim 17, wherein each of the control signal of the noise reduction mode and the control signal of the normal mode comprises a horizontal synchronization start signal, a load signal, and a gate pulse signal.

20. The method of claim 19, wherein the outputting of the control signal of the noise reduction mode comprises changing a frequency of each of the horizontal synchronization start signal, the load signal, and the gate pulse signal to be higher than a frequency in the normal mode.
